(19) United States
(12) Patent Application Publication
(10) Pub. No.: US 2026/0154877 A1
(43) Pub. Date: Jun. 4, 2026

(54) DISPLAY CONTROL DEVICE

(71) Applicant: TOYOTA JIDOSHA KABUSHIKI KAISHA, Toyota-shi (JP)

(72) Inventors: Arata TAKADA, Toyota-shi (JP); Tsutomu HATTORI, Toyota-shi (JP); Shogo KONISHI, Nagoya-shi (JP); Takashi NISHIDA, Chiryu-shi (JP)

(73) Assignee: TOYOTA JIDOSHA KABUSHIKI KAISHA, Toyota-shi (JP)

(21) Appl. No.: 19/357,288

(22) Filed: Oct. 14, 2025

(30) Foreign Application Priority Data
Oct. 22, 2024 (JP) 2024-185957

(51) Int. Cl. G06T 11/60

(52) U.S. Cl. CPC G06T 11/60

(57) ABSTRACT

A display control device including: a display control section that displays, on a display portion, an own lane image showing an own lane in which an own vehicle travels, the own lane image including, a rectilinear segment positioned at a near side as seen from a viewer and fixed in a rectilinear form, and a curved segment positioned further toward a far side than the rectilinear segment and curved in a curved shape in accordance with a curve of the own lane.

### CROSS-REFERENCE TO RELATED APPLICATION

This application claims priority under 35 USC 119 from Japanese Patent Application No. 2024-185957, filed on Oct. 22, 2024, the disclosure of which is incorporated by reference herein.

### BACKGROUND

### Technical Field

The present disclosure relates to a display control device.

### Related Art

Japanese Patent Application Laid-Open (JP-A) No. 2023-045138 discloses displaying an image, which corresponds to roads in the vicinity of where the own vehicle is traveling, and mark M1, which indicates the position of the own vehicle, in display region V3 of a head-up display device (refer to paragraph [0059] and FIG. 4 of JP-A No. 2023-045138). In particular, FIG. 4 of JP-A No. 2023-045138 illustrates a state in which an “image corresponding to the road on which the own vehicle is traveling and the vicinity thereof” is, in correspondence with the road curving toward the left, curved toward the left from the position at the nearest side toward the position at the furthest side as seen from the passenger of the vehicle.

In the technique described in this JP-A No. 2023-045138, in a case in which the vehicle is traveling on a road in which curves successively appear such as a mountain road for example, accompanying the changes in the curved state of the road, the changes in the lane image showing the lane in which the vehicle travels become excessive, and there is the concern that the viewer of the image may feel annoyed.

### SUMMARY

The present disclosure provides a display control device that may suppress a viewer of an image feeling that the display is annoying.

A first aspect is a display control device including: a display control section that displays, on a display portion, an own lane image showing an own lane in which an own vehicle travels, the own lane image including, a rectilinear segment positioned at a near side as seen from a viewer and fixed in a rectilinear form, and a curved segment positioned further toward a far side than the rectilinear segment and curved in a curved shape in accordance with a curve of the own lane.

In the first aspect, the own lane image, which shows the own lane in which the own vehicle travels, includes the rectilinear segment that is fixed in a rectilinear form, and the curved segment that is curved in a curved shape in accordance with the curve of the own lane. Due thereto, even in a case in which the own lane is a road on which curves appear successively, the rectilinear segment of the own lane image remains as is in a rectilinear form and does not change regardless of the changes in the curved state of the road. Therefore, the viewer of the image feeling that the display is annoying may be suppressed.

In a second aspect, in the first aspect, display control section, may display an own vehicle image, which shows the own vehicle, so as to be superposed on the own lane image, and may extends the rectilinear segment of the own lane image to further toward the far side than a displayed position of the own vehicle image.

In the second aspect, the rectilinear segment of the own lane image is extended to further toward the far side than the displayed position of the own vehicle image that shows the own vehicle. Therefore, even if the curved state of the road changes, the own lane image in a vicinity of the displayed position of the own vehicle image remains as is in a rectilinear form and does not change. Due thereto, in a case of a structure that displays the own vehicle image along a direction in which the own lane extends in a vicinity of the displayed position of the own vehicle image in the own lane image, even if the curved state of the road changes, the own vehicle image is maintained as is in a state of advancing straight forward, and the viewer of the image feeling that the display is annoying may be suppressed even more.

In a third aspect, in the first aspect, the display control section may display, the own lane image provided with an oppositely curved segment, which is curved in a direction opposite the curved segment, provided between the rectilinear segment and the curved segment.

Sensory evaluations that were carried out by the inventors of the present invention and others obtained evaluation results, expressing that it is more difficult to give a viewer a sense of incongruity in a case in which the above-described oppositely curved segment is provided between the rectilinear segment and the curved segment of the own lane image, than in a case in which the oppositely curved segment is not provided. Therefore, in accordance with the third aspect, the viewer of the image being given a sense of incongruity may be suppressed.

In accordance with the above-described aspects, the display control device of the present disclosure may suppress a viewer of an image feeling that the display is annoying.

### BRIEF DESCRIPTION OF THE DRAWINGS

An exemplary embodiment will be described in detail based on the following figures, wherein:

FIG. 1 is a block drawing illustrating the schematic structure of an onboard system relating to an embodiment;

FIG. 2 is a flowchart illustrating an example of own lane image generating processing;

FIG. 3 is an image drawing illustrating an example of an own lane image;

FIG. 4 is an image drawing illustrating an example of an image displayed on a display portion; and

FIG. 5 is an image drawing illustrating another example of an image displayed on the display portion.

### DETAILED DESCRIPTION

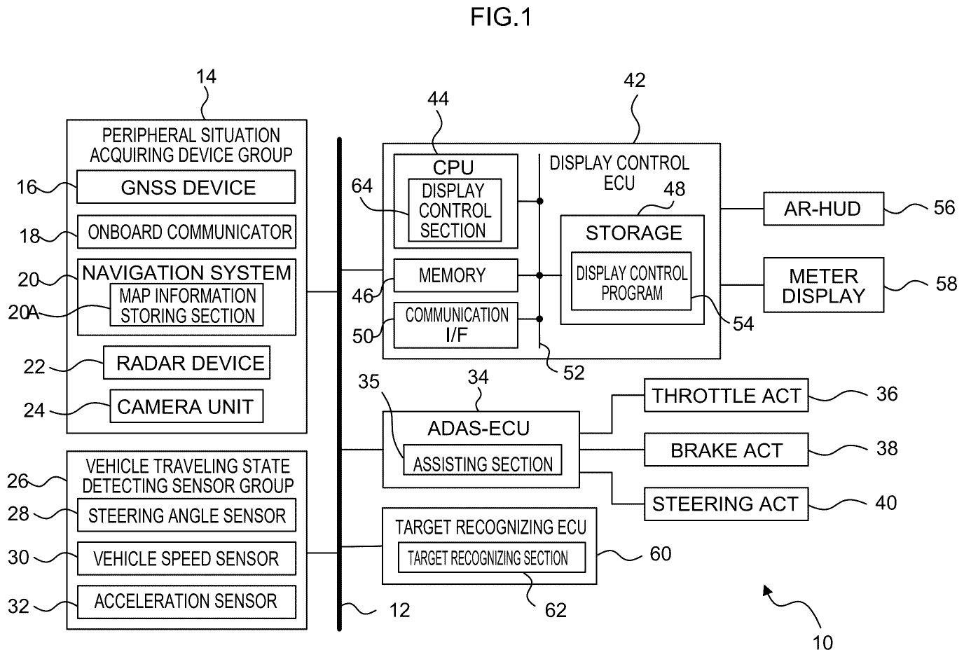

An example of an embodiment of the present disclosure is described in detail hereinafter with reference to the drawings. As illustrated in FIG. 1, an onboard system 10 relating to the present embodiment has a communication bus 12. A peripheral situation acquiring device group 14, a vehicle traveling state detecting sensor group 26, a target recognizing ECU (Electronic Control Unit) 60, an ADAS (Advanced Driver-Assistance System)—ECU 34, and a display control ECU 42 are respectively connected to the communication bus 12. Note that only a portion of the onboard system 10 is illustrated in FIG. 1. Further, the vehicle in which the onboard system 10 is installed will be called the own vehicle hereinafter.

The peripheral situation acquiring device group 14 includes, as devices that acquire information expressing what type of situation the peripheral environment of the own vehicle is in, a GNSS (Global Navigation Satellite System) device 16, an onboard communicator 18, a navigation system 20, a radar device 22 and a camera unit 24.

The GNSS device 16 receives GNSS signals from plural GNSS satellites and measures the position of the own vehicle. The onboard communicator 18 carries out at least one of inter-vehicle communication with other vehicles and road-to-vehicle communication with roadside devices. The navigation system 20 includes a map information storing section 20A that stores map information. On the basis of the position information obtained from the GNSS device 16 and the map information stored in the map information storing section 20A, the navigation system 20 carries out processings such as displaying the position of the own vehicle on a map, and determining and guiding the path to the destination.

The radar device 22 detects objects, such as other vehicles and pedestrians that exist at the periphery of the own vehicle, as point cloud information, and acquires the relative positions and the relative speeds between the own vehicle and the detected objects. Further, on the basis of changes in the relative positions and relative speeds of the individual objects, the radar device 22 excludes, from subjects of monitoring, noise and roadside objects such as guardrails, and outputs the information of the relative positions and the relative speeds of the objects that are the subjects of monitoring (targets) such as other vehicles and pedestrians. The camera unit 24 captures images of the periphery of the own vehicle by plural cameras, and outputs the captured images.

The vehicle traveling state detecting sensor group 26 includes, as plural sensors that acquire the traveling state of the own vehicle, a steering angle sensor 28 that detects the steering angle of the own vehicle, a vehicle speed sensor 30 that detects the traveling speed of the own vehicle, and an acceleration sensor 32 that detects acceleration applied to the own vehicle.

Although not illustrated, the target recognizing ECU 60 incorporates therein a CPU (Central Processing Unit), a memory such as a ROM (Read Only Memory) or a RAM (Random Access Memory), and a storage such as an HDD (Hard Disk Drive) or an SSD (Solid State Drive). A predetermined program that makes the CPU of the target recognizing ECU 60 function as a target recognizing section 62 is stored in the storage. From images of the region in front of the own vehicle which are captured by the camera unit 24, the target recognizing section 62 recognizes the boundaries of the lane in which the own vehicle is traveling (the own lane). In this own lane recognition, the target recognizing section 62 also recognizes whether or not the own lane is curving, and if the own lane is curving, also recognizes the turning direction and the radius of curvature thereof. Further, the target recognizing section 62 recognizes targets at the periphery of the own vehicle that are shown in the images captured by the camera unit 24 (vehicles traveling in the own lane and in adjacent lanes), and recognizes the types of these targets (e.g., standard-size cars or large vehicles), and detects/outputs the distances between the own vehicle and the targets. Further, the target recognizing section 62 detects/outputs the distance calculated by combining the depth to a target that is detected by the radar device 22 and the orientation of the target that is detected by a camera.

A throttle ACT 36 that changes the degree of opening of the throttle of the own vehicle, a brake ACT 38 that changes the braking force generated by the brake device of the own vehicle, and a steering ACT 40 that changes the amount of steering by the steering device of the own vehicle, are respectively connected to the ADAS-ECU 34.

Although not illustrated, the ADAS-ECU 34 includes a CPU, a memory such as a ROM or a RAM, a storage such as an HDD or an SSD, and a communication I/F (InterFace). A predetermined program for making the CPU of the ADAS-ECU 34 function as an assisting section 35 is stored in the storage. When the own vehicle is in a drive assist mode, on the basis of information obtained from the peripheral situation acquiring device group 14 and the vehicle traveling state detecting sensor group 26 and the results of recognizing targets by the target recognizing section 62, the assisting section 35 controls the throttle ACT 36, the brake ACT 38 and the steering ACT 40, and carries out assisting processing that assists at least one of acceleration/deceleration and steering of the own vehicle. Examples of drive assist functions realized by this assisting processing are ACC (Adaptive Cruise Control) that causes the own vehicle to travel so as to following a preceding vehicle traveling in the own lane, and LKA (Lane Keeping Assist) that assists steering such that the own vehicle travels in the center of the own lane.

The display control ECU 42 includes a CPU 44, a memory 46 such as a ROM or a RAM, a storage 48 such as an HDD or an SSD, and a communication I/F 50. The CPU 44, the memory 46, the storage 48 and the communication I/F 50 are connected so as to be able to communicate with one another via an internal bus 52. A display control program 54 is stored in the storage 48. Due to the display control program 54 being read-out from the storage 48 and expanded in the memory 46, and the display control program 54 that has been expanded in the memory 46 being executed by the CPU 44, the display control ECU 42 functions as a display control section 64, and carries out own lane image generating processing that is described later.

An AR (Augmented Reality)—head-up display (hereinafter called AR-HUD) 56 and a meter display 58 are connected to the display control ECU 42. The AR-HUD 56 relating to the present embodiment is a compact HUD that, by reflection onto the windshield glass or the like, makes a portion of the frontward field of view of the passenger of the own vehicle be a display region (connects an image to the lower part of the foreground). Further, the meter display 58 is a display provided at the instrument panel of the own vehicle. The display control ECU 42 controls the display of information onto the AR-HUD 56 and the meter display 58. Note that, the display control ECU 42 is an example of the display control device relating to the present disclosure, and the AR-HUD 56 and the meter display 58 are examples of the display portion in the present disclosure.

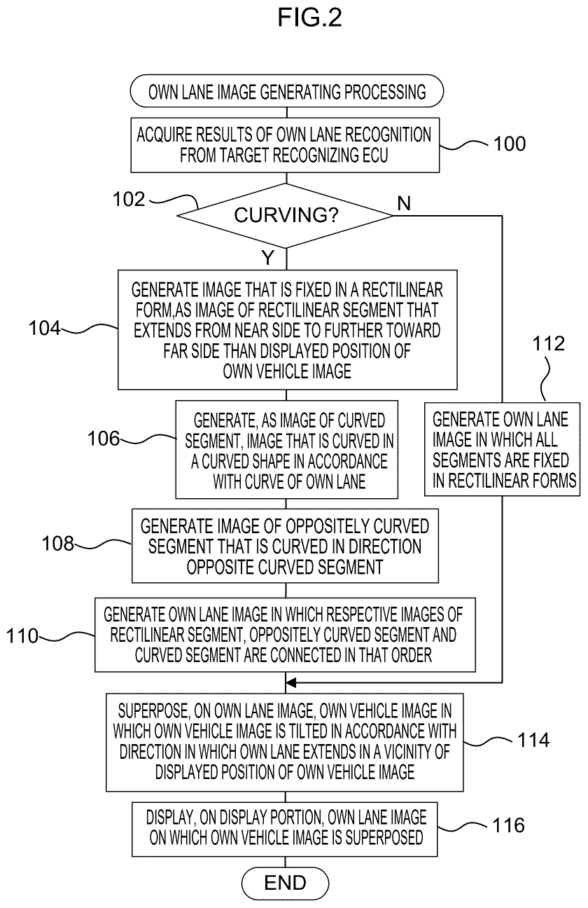

Own lane image generating processing, which is executed repeatedly by the display control ECU 42 (the display control section 64) while the ignition switch of the own vehicle is on, is described next as the operation of the present embodiment and with reference to FIG. 2.

In step 100 of the own lane image generating processing, the display control section 64 acquires the results of own lane recognition from the target recognizing ECU 60. In next step 102, on the basis of the results of the own lane recognition acquired in step 100, the display control section 64 judges whether or not the own lane is curving. If the judgement in step 102 is negative, the routine moves on to step 112. In step 112, the display control section 64 generates an own lane image in which the boundaries of the own lane are fixed in rectilinear forms in all of the segments from the nearest side to the furthest side as seen from the viewer of the image. When the processing of step 112 is carried out, the routine moves on to step 114.

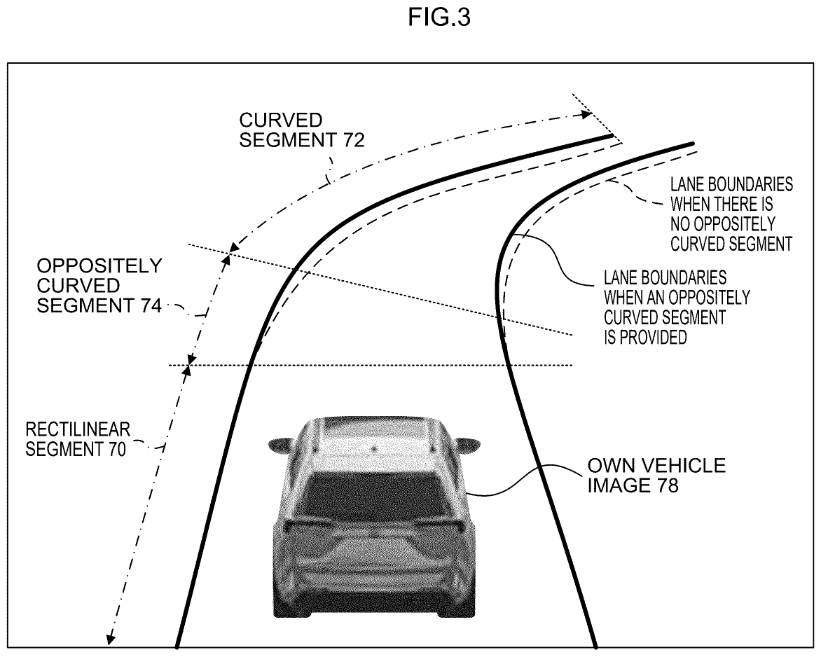

On the other hand, if the judgement in step 102 is affirmative, the routine moves on to step 104. In step 104, the display control section 64 generates an image in which the boundaries of the own lane are fixed in rectilinear forms, as the image of a rectilinear segment 70 (see FIG. 3) that extends from the nearest side to further toward the far side than the displayed position of the own vehicle image as seen from the viewer of the image, in the own lane image. In step 106, the display control section 64 generates an image in which the boundaries of the own lane are curved in curved shapes in accordance with the radius of curvature of the curve of the own lane, as the image of a curved segment 72 (see FIG. 3) that is positioned further toward the far side than the rectilinear segment as seen from the viewer of the image, in the own lane image.

Note that, even in a case in which the own vehicle is approaching a curve of a constant radius of curvature, there are cases in which the value of the radius of curvature of the curve that is detected by the target recognizing ECU 60 exhibits vibrational changes over time. In consideration of such a possibility, the extent of the curvature of the boundaries of the own lane in the image of the curved segment 72 is preferably determined on the basis of a value that damps the temporal changes of the detected value of the radius of curvature of the curve detected by the target recognizing ECU 60, e.g., the moving average value of the detected value of the radius of curvature. Due thereto, the extent of the curvature of the boundaries of the own lane in the curved segment 72 of the own lane image exhibiting vibrational changes over time may be suppressed, and the display of the curved segment 72 becoming annoying may be suppressed.

In next step 108, the display control section 64 generates an image that is curved in the direction opposite the curved segment, as the image of an oppositely curved segment 74 (see FIG. 3) that is disposed between the rectilinear segment and the curved segment in the own lane image. Note that the oppositely curved segment 74 can also be called a slightly curved segment in which the extent of curvature of the lane is smaller than that of the curved segment. Then, in step 110, the display control section 64 generates an own lane image that connects, in order, the image of the rectilinear segment generated in step 104, the image of the oppositely curved segment 74 generated in step 108, and the image of the curved segment 72 generated in step 106. When the processing of step 110 is carried out, the routine moves on to step 114.

In step 114, the display control section 64 superposes an own vehicle image 78 (see FIG. 3), in which the own vehicle image is tilted along the direction in which the own lane extends in a vicinity of the displayed position of the own vehicle image, on the own lane image that was generated in step 112 or step 110. In this superposing processing, if the direction in which the own lane extends in a vicinity of the displayed position of the own vehicle image is tilted with respect to the direction of advancing straight forward, the own vehicle image 78 that is in a state of being tilted with respect to a state of advancing straight forward is superposed on the own lane image. However, in the present embodiment, because the rectilinear segment 70 of the own lane image is fixed in a rectilinear form even if the own lane is curving, the own vehicle image that is superposed on the own lane image is maintained as is in the state of advancing straight forward (the state illustrated in FIG. 3) even if the own lane is curving.

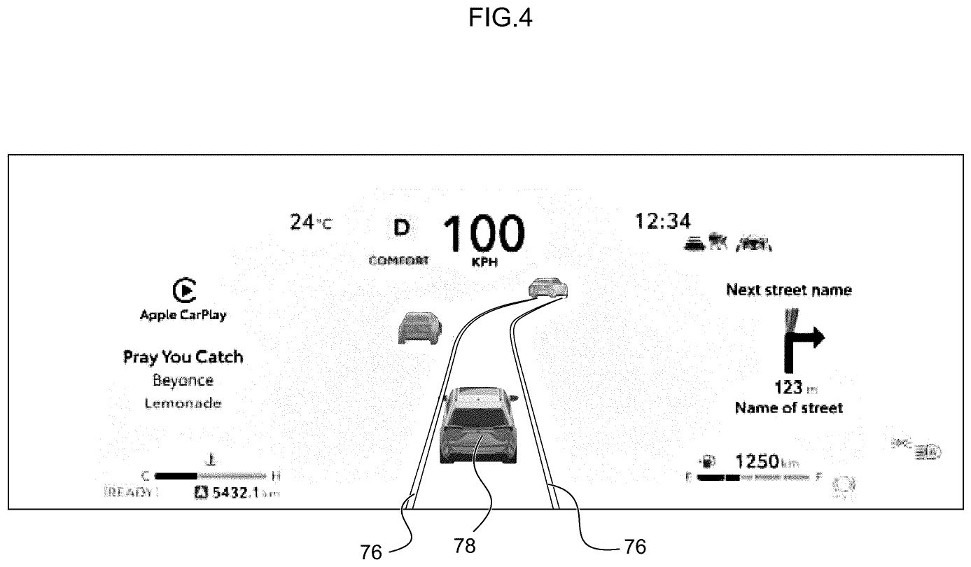

Further, in step 116, the display control section 64 displays an own lane image 76, on which the own vehicle image is superposed, on a display portion (at least one of the AR-HUD 56 and the meter display 58) as illustrated in FIG. 4 as an example, and ends the own lane image generating processing. Note that FIG. 4 illustrates in example in which an image, which is formed from boundary lines on both sides that demarcate the own lane, is displayed on the meter display 58 as the own lane image 76.

In this way, in the present embodiment, the display control section 64 displays, on a display portion and as the own lane image 76 that shows the own lane in which the own vehicle travels, an image that includes the rectilinear segment 70 that is positioned at the near side as seen from the viewer of the image and is fixed in a rectilinear form, and the curved segment 72 that is positioned further toward the far side than the rectilinear segment 70 and is curved in a curved shape in accordance with the curve of the own lane. Due thereto, even in a case in which the own vehicle is traveling on a road in which curves appear successively, the viewer of the image feeling that the display of the display portion is annoying may be suppressed.

Further, in the present embodiment, the display control section 64 displays the own vehicle image 78, which shows the own vehicle, so as to be superposed on the own lane image 76, and extends the rectilinear segment 70 of the own lane image 76 to further toward the far side than the displayed position of the own vehicle image 78. Due thereto, even if the curved state of the road on which the own vehicle travels changes, the own vehicle image 78 is maintained as is in a state of advancing straight forward, and the viewer of the image feeling that the display of the display portion is annoying may be suppressed even more.

Still further, in the present embodiment, the display control section 64 displays, as the own lane image 76, an image in which the oppositely curved segment 74, which is curved in the direction opposite the curved segment 72, is provided between the rectilinear segment 70 and the curved segment 72. Due thereto, the viewer of the image being given a sense of incongruity may be suppressed.

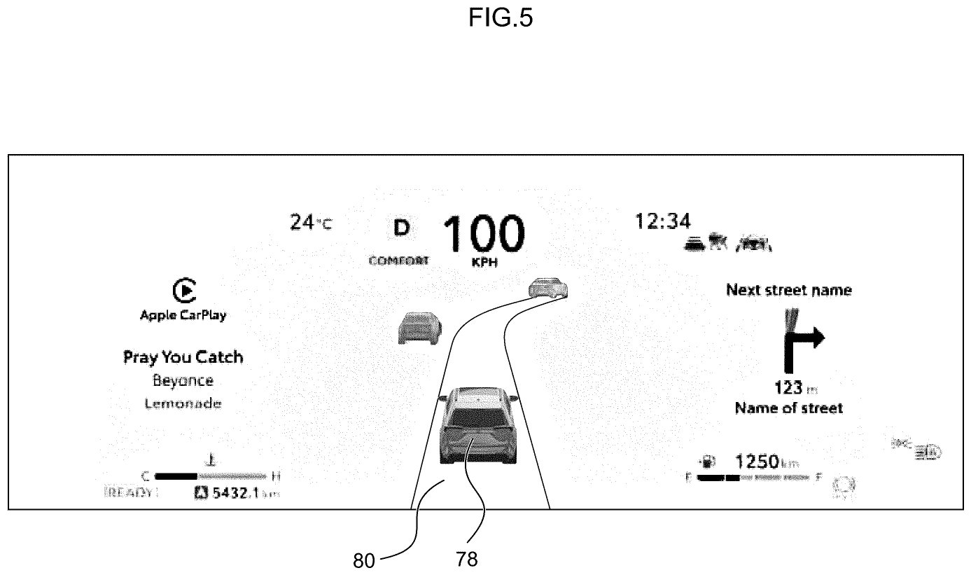

Note that FIG. 4 illustrates an example in which an image, which is formed from boundary lines at both sides that demarcate the own lane, is displayed as the own lane image 76 on the meter display 58. However, the own lane image that is displayed on the display portion is not limited to this, and, as shown in FIG. 5 as an example, may be an image in which the own lane is filled-in in the shape of a strip.

Further, the above embodiment describes an aspect in which an image, which is provided with the rectilinear segment 70, the oppositely curved segment 74 and the curved segment 72, is displayed on a display portion as the own lane image in a case in which the own lane is curving. However, the present disclosure is not limited to this, and an image formed from the rectilinear segment 70 and the curved segment 72 (an image in which the oppositely curved segment 74 is omitted) may be displayed as the own lane image in a case in which the own lane is curving.

Moreover, in the above-described embodiment, the length of the rectilinear segment 70 of the own lane image in a case in which the own lane is curving is not particularly mentioned. However, for example, the length of the rectilinear segment 70 may be made to become shorter as radius of curvature of the curve of the own lane becomes smaller. However, even in a case in which the length of the rectilinear segment 70 is made shorter, it is preferable that the rectilinear segment 70 be made to extend to further toward the far side than the displayed position of the own vehicle image.

Further, although the above embodiment describes an aspect in which an image provided with at least the rectilinear segment 70 is displayed on a display portion as the own lane image in a case in which the own lane is curving, the present disclosure is not limited to this. For example, display may be made able to switch between displaying an image provided with at least the rectilinear segment 70 and displaying an image in which the rectilinear segment 70 is omitted (an image formed only from the curved segment 72, e.g., the image illustrated in FIG. 4 of JP-A No. 2023-045138), as the own lane image in a case in which the own lane is curving.

Still further, the above embodiment describes an aspect in which the display control program 54 for causing the display control ECU 42 to function as the display control section 64 is stored in advance (is installed) in the storage 48. However, the display control program 54 can be provided in a form of being recorded on a non-transitory recording medium such as an HDD, an SSD or a DVD.

What is claimed is:

1. A display control device comprising:
a memory; and
a processor coupled to the memory and to a display, the processor being configured to cause to be displayed, on the display, an own lane image showing an own lane in which an own vehicle travels, the own lane image including:
a rectilinear segment positioned at a near side as seen from a viewer and fixed in a rectilinear form, and
a curved segment positioned further toward a far side than the rectilinear segment and curved in a curved shape in accordance with a curve of the own lane.

2. The display control device of claim 1, wherein the processor is configured to:
display an own vehicle image, which shows the own vehicle, so as to be superposed on the own lane image, and
extend the rectilinear segment of the own lane image to further toward the far side than a displayed position of the own vehicle image.

3. The display control device of claim 1, wherein the processor is configured to cause display of the own lane image provided with an oppositely curved segment, which is curved in a direction opposite the curved segment, provided between the rectilinear segment and the curved segment.
